(19) United States
(12) Patent Application Publication
(10) Pub. No.: US 2026/0343388 A1
(43) Pub. Date: Oct. 29, 2026

(54) MULTI-AP COORDINATION ACROSS ADMINISTRATIVE DOMAINS AND COORDINATED TRANSMIT OPPORTUNITY (TXOP) LIMITS

(71) Applicant: Cisco Technology, Inc., San Jose, CA (US)

(72) Inventors: Brian D. Hart, Sunnyvale, CA (US); Binita Gupta, San Diego, CA (US); Malcolm M. Smith, Richardson, TX (US)

(21) Appl. No.: 19/398,409

(22) Filed: Nov. 24, 2025

Related U.S. Application Data
(60) Provisional application No. 63/793,787, filed on Apr. 24, 2025.
(60) Provisional application No. 63/793,791, filed on Apr. 24, 2025.

(51) Int. Cl. H04W 48/16; H04W 74/00; H04W 88/10

(52) U.S. Cl. CPC H04W 48/16; H04W 74/002; H04W 88/10

(57) ABSTRACT

Techniques (and detailed protocol elements) that enable minimum capabilities and policies to be established and adequately helpful behavior to be maintained for Multi-Access Point Coordination (MAPC), with signal-able warnings when this does not occur and what specific concerns arise. These techniques enable MAPC to work across different administrative domains, vendors, SKUs and software versions. In addition, a method is provided comprising: at a first access point (AP), advertising to one or more other APs including a second AP, support for coordinated transmit opportunity (TXOP) limits by transmitting frames indicating support for coordinated TXOP limits; negotiating, with the second AP, coordinated TXOP limits and related parameters using one or more frame sequences between the first AP and the second AP; and at conclusion of the negotiating, engaging in operations in respective basic service sets of the first AP and the second AP according to the coordinated TXOP limits.

### CROSS-REFERENCE TO RELATED APPLICATIONS

This application claims priority to U.S. Provisional Patent Application No. 63/793,787, filed Apr. 24, 2025, entitled “Multi-AP Coordination Across Administrative Domains” and to U.S. Provisional Patent Application No. 63/793,791, filed Apr. 24, 2025, entitled “Coordinated Transmit Opportunity (TXOP) Limits.” The entirety of each of these applications is incorporated herein by reference.

### TECHNICAL FIELD

The present disclosure relates to wireless networks.

### BACKGROUND

When deploying wireless local area networks, there may be circumstances in which two wireless access points (APs) that are in different administrative domains are in wireless proximity to each other. For example, a first AP is in a first administrative domain in a coffee shop that is adjacent (and hence in wireless proximity) to a second AP in a bookstore. The APs can gain benefits from Multi-AP Coordination (MAPC) such as lower-latency and higher capacity, but the APs also need to be wary that the other AP is not taking advantage of it, from a network security perspective.

### BRIEF DESCRIPTION OF THE DRAWINGS

FIG. 1 illustrates a block diagram of a wireless network that includes wireless clients and access points (APs) and in which an AP can conduct Multi-AP Coordination (MAPC) exchanges to determine overlapping capabilities for MAPC across different administrative domains, according to an example embodiment.

FIG. 2 is a diagram depicting a mechanism by which APs may discover capabilities and requirements of other APs in different administrative domains, according to an example embodiment.

FIG. 3 is a diagram depicting a mechanism by which APs may negotiate a MAPC relationship with APs in different administrative domains, according to an example embodiment.

FIG. 4 is a diagram of MAPC related fields that may be used to signal capabilities and requirements of APs to negotiate a MAPC agreement, according to an example embodiment.

FIGS. 5A and 5B are diagrams illustrating examples of how to signal values of certain parameters that pertain to a MAPC agreement between APs across administrative domains, according to an example embodiment.

FIG. 6 is a flow chart depicting a method by which two APs in different administrative domains may negotiate a MAPC agreement, according to an example embodiment.

FIG. 7 is a flow chart depicting a method by which two APs may negotiate coordinate transmit opportunity (TXOP) limits, according to an example embodiment.

FIG. 8 illustrates a hardware block diagram of a device that may perform the functions of a wireless access point in connection with the techniques presented herein.

### DESCRIPTION OF EXAMPLE EMBODIMENTS

### Overview

Presented herein are techniques (and detailed protocol elements) that enable minimum capabilities and policies to be established and adequately helpful behavior to be maintained for multi-Access Point Coordination (MAPC), with signal-able warnings when this does not occur and what specific concerns arise. These techniques enable MAPC to work for APs across different administrative domains, vendors, SKUs and software versions.

In one embodiment, a method is provided for MAPC across administrative domains, comprising: at a first AP in a first administrative domain sending a request to a second AP in a second administrative domain that is in wireless proximity to the first AP, the request including information indicating capabilities of the first AP and requirements of the second AP for a MAPC agreement with the first AP, wherein the requirements of the second AP are defined as a minimum, a maximum or a range of tolerable values for each parameter among a list of one or more parameters and the list includes at least one parameter related to fair channel access and/or channel access enabling better Quality of Service (QoS) or reliability. At the second AP, the method involves evaluating the information contained in the request to determine whether to accept the request, reject the request or reject the request with a counterproposal that includes information of the second AP indicating capabilities of the second AP and requirements of the first AP for a MAPC agreement with the second AP, wherein the requirements of the first AP are defined as a minimum, maximum or range of tolerable values for each parameter among the list of one or more parameters and include at least one parameter related to fair channel access and/or channel access enabling better QoS or reliability. The method further involves the second AP sending to the first AP a response based on the evaluating.

In another embodiment, a system is provided comprising: a first AP in a first administrative domain; and a second AP in a second administrative domain that is in wireless proximity to the first AP. The first AP is configured to: send a request to the second AP, the request including information indicating capabilities of the first AP and requirements of the second AP for a MAPC agreement with the first AP, wherein the requirements of the second AP are defined as a minimum, a maximum or a range of tolerable values for each parameter among a list of one or more parameters and the list includes at least one parameter related to fair channel access and/or channel access enabling better Quality of Service (QoS) or reliability. The second AP is configured to: evaluate the information contained in the request to determine whether to accept the request, reject the request or reject the request with a counterproposal that includes information of the second AP indicating capabilities of the second AP and requirements of the first AP for a MAPC agreement with the second AP, wherein the requirements of the first AP are defined as a minimum, maximum or range of tolerable values for each parameter among the list of one or more parameters and include at least one parameter related to fair channel access and/or channel access enabling better QoS or reliability; and send to the first AP a response.

In still another embodiment, a method is provided comprising: at a first access point (AP), advertising to one or more other APs including a second AP, support for coordinated transmit opportunity (TXOP) limits by transmitting frames indicating support for coordinated TXOP limits; negotiating, with the second AP, coordinated TXOP limits and related parameters using one or more frame sequences between the first AP and the second AP; and at conclusion of the negotiating, engaging in operations in respective basic service sets of the first AP and the second AP according to the coordinated TXOP limits.

### Example Embodiments

### MAPC Across Administrative Domains

Multi-Access Point (AP) Coordination (MAPC) across administrative domains can present opportunities as well as challenges, such as network security challenges. As explained above, the APs can achieve benefits from MAPC, such as lower-latency and higher capacity, but the APs need to be able to trust that one AP is not taking advantage of the other AP. One possible level of trust is one AP may be configured to communicate to the other that: “I will help you with channel access as asked when and while you help me with channel access when I need your help”. Another level of trust may be one AP communicating to the other AP that “I have no objections to your channel access as I do not have high Quality of Service stations (STAs)”.

A careful MAPC implementation should have a) minimal expectations for what the APs want out of the coordination, b) the ability to coach the other AP(s) to do better when applicable, and c) to sever the MAPC relationship if it is not working out. This involves defined signaling, which is not heretofore known.

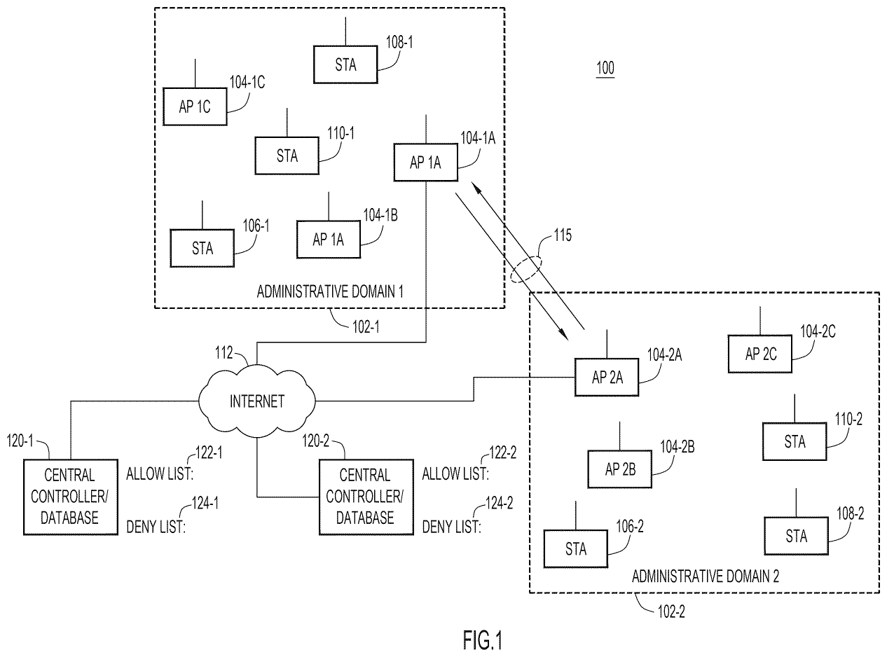

FIG. 1 illustrates a system 100 in which there are APs in different administrative domains, but in wireless proximity to each other. For example, there is a first administrative domain 102-1, denoted Administrative Domain 1, and a second administrative domain 102-2, denoted Administrative Domain 2. These administrative domains may be operating in the same multi-tenant building (e.g., office building) and be associated with a different enterprise/business. For example, administrative domain 102-1 is on the 12th floor and administrative domain 102-2 is on the 11th floor of a building. Alternatively, a shopping center or mall may have different stores that share an adjacent common wall such that administrative domain 102-1 and administrative domain 102-2 are different business entities operating in adjacent spaces. The administrative domains 102-1 and 102-2 may have APs made by the same manufacturer or by different manufacturers.

There is a first AP 104-1A operating in administrative domain 102-1 to provide wireless local area network (WLAN) connectivity for clients or stations (STAs) 106-1, 108-1 and 110-1 in administrative domain 102-1. Similarly, there is a second AP 104-2A operating in administrative domain 102-2 to provide WLAN connectivity for STAs 106-2, 108-2 and 110-2 operating in administrative domain 102-2. Each of the APs 104-1A and 104-2A may be connected, e.g., by wired connection, to the Internet 112. Due to their wireless proximity, AP 104-1A and AP 104-2A can interfere with each other if they are operating on the same channels.

Each administrative domain may have one or more APs. Thus, as shown in FIG. 1, in administrative domain 102-1 there are APs 104-1B and 104-1C and potentially even more APs. Likewise, in administrative domain 102-2 there are APs 104-2B and 104-2B and potentially even more APs. Furthermore, though not specifically illustrated as such for simplicity, it is to be understood that the APs within each administrative domain can communicate with each other, either by wire as part of a distributed system (DS) or wirelessly. Moreover, each of the APs in one administrative domain may be in wireless proximity to zero or more APs in a different administrative domain.

Moreover, the system 100 may include a cloud-based central controller/database for each of the administrative domains. For example, there is a first central controller/database 120-1 that is in communication with APs 104-1A, 104-1B and 104-1C in the administrative domain 102-1. The central controller/database 120-1 may be remote (cloud-based) or reside on-prem of the enterprise associated with the administrative domain 102-1. Similarly, there is a second central controller/database 120-2 associated with the administrative domain 102-2 and is communication with APs 104-2A, 104-2B and 104-2C of the administrative domain 102-1. Each central controller/database 120-1 and 120-2 may store information pertaining to experiences of APs (of its associated administrative domain) in connection with MAPC relationships with APs in another administrative domain. For example, the first central controller/database 120-1 receives experience reports for the first AP 104-1A and other APs in the administrative domain 102-1 in connection with MAPC agreement relationships with the second AP and other APs in the administrative domain 102-2. Similarly, the second central controller/database 120-2 receives experience reports for the second AP 104-2A and other APs in the administrative domain 102-2 in connection with MAPC agreement relationships with the first AP 104-1A and other APs in the administrative domain 102-1. APs may report their positive or negative experiences of a peer AP to its associated central controller/database, tagged with its vendor and/or software version(s). The central controller/database 120-1 may use analytics to establish, on behalf of APs in the administrative domain 102-1, an Allow List 122-1 of sufficiently trustworthy AP models and/or software (SW) versions and/or a Deny List 124-1 of insufficiently trustworthy AP models and SW versions. Similarly, the central controller/database 120-2 may use analytics to establish, on behalf of APs in the administrative domain 102-2, an Allow List 122-2 of sufficiently trustworthy AP models and/or software (SW) versions and/or a Deny List 124-2 of insufficiently trustworthy AP models and SW versions. Before attempting to establish a MAPC agreement with a peer AP, the Requester AP and/or Responder AP may ping its domain-specific central controller/database 120-1 or 120-2, as the case may be, to determine if the peer AP in another administrative domain is adequately trustworthy.

In one example embodiment, one or more of the APs 104-1A, 104-1B, 104-1C, 104-2A, 104-2B and 104-2C and one or more of the STAs in each administrative domain may have multi-link operation (MLO) capabilities. In this regard, the APs may be referred to as AP multi-link devices (MLDs). Similarly, the STAs in each administrative domain may be MLO-capable and be referred to as non-AP MLDs. However, it should be noted that the cross-administrative domain MAPC techniques presented herein do not require that the APs and STAs be MLO capable.

The respective APs in the different administrative domains are owned/operated by different organizations and there is no particular incentive for organization/entity of administrative domain 1 to help the organization/entity of administrative domain 2, or vice versa. There is an opportunity for one AP to take advantage of the other AP. If they are both APs made by the same manufacturer but owned and operating by different customers of that manufacturer, there may be less likelihood of such exploitation. However, if one AP, e.g., AP 104-1A is made by a first manufacturer and AP 104-2A is made by a second manufacturer, due to the inherent competitiveness between AP manufacturers there is an incentive from the silicon vendor, the system vendor or the end customer to tweak the parameters or tweak the algorithms for one AP to take advantage of the other AP.

Furthermore, the APs do not have traffic to send at all times. For example, if AP 104-1A is an enterprise AP and AP 104-2A is a residential AP, AP 104-1A may have much more traffic during an 8-hour workday than the traffic handled by AP 104-2A during the same time period. Conversely, AP 104-1A may have much less traffic to serve outside of the 8-hour workday whereas AP 104-2A may have more traffic during such times.

Therefore, fairness is not really an equitable distribution of resources. A working definition of trust may be: “I'll help you with channel access--just ask when and why. Will you help me with your access when I need your help.” It is effectively an on demand-based fairness model.

In one example, AP 104-1A and AP 104-1A engage in an MAPC exchange 115 to negotiate a MAPC agreement in order to enable MAPC operation between them, even though they are in different administrative domains.

Presented herein are the MAPC AP-to-AP (AP2AP) messages/frames that may be sent between APs as part of MAPC exchanges to establish and terminate a cross-domain MAPC agreement between two APs.

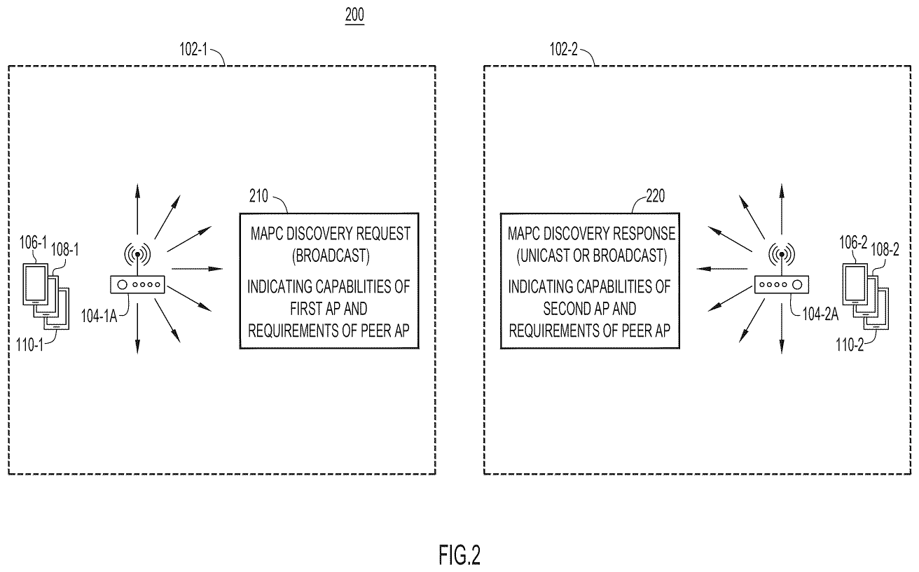

Turning now to FIG. 2, a diagram is shown depicting a process 200 for first AP 104-1A and second AP 104-2A in administrative domains 102-1 and 102-2, respectively, to discover the requirements and capabilities of each other. For example, first AP 104-1A may broadcast a MAPC Discovery Request 210 that includes information indicating capabilities of the first AP 104-1A and requirements of a peer AP (e.g., the second AP) for a MAPC agreement with the first AP 104-1A. A peer AP, such as AP 104-2A, that receives the MAPC Discovery Request 210 may respond to the first AP 104-1A by transmitting a MAPC Discovery Response 220 either as a unicast message or a broadcast message. The MAPC Discovery Response 220 includes information indicating capabilities of the second AP and requirements of a peer AP (e.g., the first AP 104-1A) for a MAPC agreement with the second AP. Further details for examples of the content and format of the information indicating capabilities and requirements are described below.

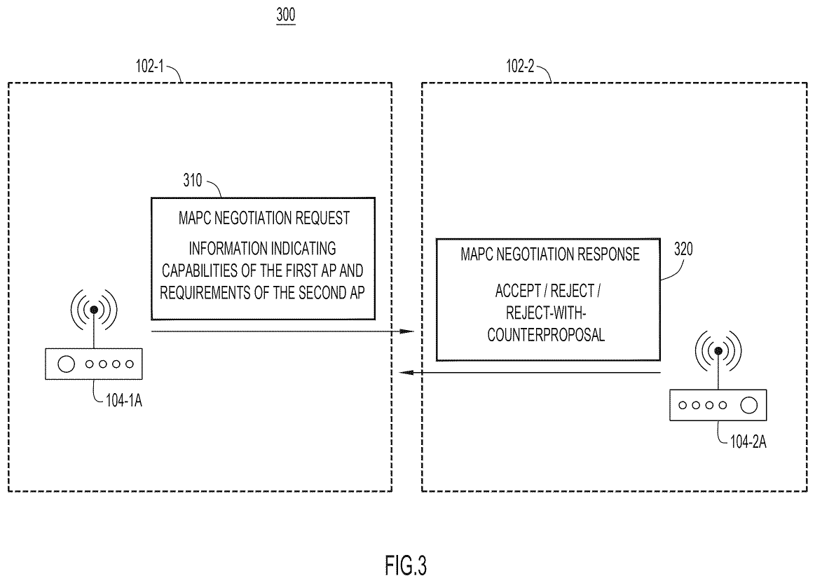

Turning now to FIG. 3, a diagram is shown for a process 300 for an exchange of MAPC messages to consummate a MAPC agreement between APs in different administrative domains, but in wireless proximity to each other such that the two APs can receive and respond to transmissions from each other. In this example, the first AP 104-1A in administrative domain 102-1 transmits a MAPC Negotiation Request 310 to the second AP 104-2A in administrative domain 102-2. The MAPC Negotiation Request 310 includes information indicating capabilities of the first AP 104-1A and requirements of the second AP 104-2A for a MAPC agreement with the first AP 104-1A. The requirements of the second AP 104-2A indicated in the MAPC Negotiation Request 310 may be defined as a minimum (lower bound), a maximum (upper bound) or a range of tolerable values for one or more parameters (or “don't care” parameters) and include at least one parameter related to fair channel access and/or channel access enabling better Quality of Service (QoS) or reliability.

To allow for the situation that the responder AP has not already discovered the requester's AP's capabilities, such as through the process 200 of FIG. 2, the requester AP (e.g., first AP 104-1A) may include its capabilities in a negotiation request (similar to High Throughput/Very High Throughput/High Efficient/Extremely High Throughput (HT/VHT/HE/EHT) Capabilities element plus the corresponding Operation elements; including extensions where a minimal/compressed (via high level abstraction) set of capabilities only are sent in the beacon, and the detailed information involves a request and (+) response exchange such as probe request and probe response or MAPC Discovery Request and MAPC Discovery Response). These capabilities and minimum requirements, requested of the responder AP, may be sent in two distinct elements/fields in the negotiation frames and each may include one or more of:
Support for one or more MAPC techniques required (bitmap for Coordinated Time Division Multiple Access (Co-TDMA), Coordinated Spatial Reuse (Co-SR), Coordinated Restricted Target Wake Time (Co-RTWT), Coordinated Beamforming (Co-BF), etc.)
Operation on the same primary channel
Operation on different primary channels
Operation on a same Non-Primary Channel Access (NPCA) primary channel
Operation on different NPCA primary channels
Operation on the same primary channel for two or more links of Multi-Link Operation (MLO)
Supports Transmit Opportunity (TXOP) limits (and the proposed minimum/maximum limits are included)
Supports Low Latency, Low Loss and Scalable (L4S) throughput/supports cross-coupled L4S. (Cross coupled L4S refers to two APs that perform L4S as if they were a single AP, i.e., treating every client equally regardless of AP the client associates to, such as in terms of access to airtime for traffic of equal priority, or some pragmatic approximation of that, that uses less over-the-air AP-to-AP communication.
Supports a protocol to report immediate traffic needs of a Basic Service Set (BSS) in a control frame within a TXOP used for MAPC
Supports AP-to-AP (AP2AP) triggering (and the minimum padding required is not over-large)
Respects start time protection rule (for Co-RTWT)
Supports Co-TDMA within Co-RTWT service periods
AP is from the same vendor, SKU and/or is running a trusted and/or signed version of code

NPCA is a mechanism (protocol) that allows devices to access secondary channels when a primary channel is occupied. This can help utilization of available bandwidth across both primary and secondary channels. NPCA works in conjunction with IEEE 802.11be to support up to 320 MHz in bandwidth, and allows for allocation of secondary channels for stations when connected to an AP that supports the full bandwidth. Devices can switch to alterative channels when a primary channel has congestion. One implementation of NPCA uses a trigger-based uplink optimization approach, thereby shifting distributed contention to centralized AP-controlled scheduling.

The second AP 104-2A evaluates the information contained in the MAPC Negotiation Request 310 to determine whether to send a MAPC Negotiation Response 320 that accepts the request, rejects the request or rejects the request with a counterproposal that includes information of the second AP indicating capabilities of the second AP and requirements of the first AP for a MAPC agreement with the second AP. The requirements of the first AP may be defined as a minimum (lower bound), a maximum (upper bound) or a range of tolerable values for one or more parameters (or “don't care” parameters) and include at least one parameter related to fair channel access and/or channel access enabling better Quality of Service (QoS) or reliability.

When the evaluating by the second AP 104-2A determines that the requirements of the second AP are not met by the capabilities of the first AP indicated in the MAPC Negotiation Request 310, the MAPC Negotiation Response 320 is a rejection of the request and includes a status code for the second AP 104-2A rejecting the request for the MAPC agreement with the first AP 104-1A.

When the evaluating by the second AP 104-2A determines that the requirements of the second AP are met by the capabilities and requirements of the first AP in the MAPC Negotiation Request 310, the MAPC Negotiation Response 320 is an acceptance of the MAPC Negotiation Request 310.

When the evaluating by the second AP 104-2A determines to reject the request with a counterproposal because the capabilities of the first AP 104-1A are outside the requirements of the second AP 104-2A, the information of the second AP included in the MAPC Negotiation Response 320 indicates which capabilities or minimum requirements of the first AP 104-1A are one of a selection that includes two or more of: a required value, a ‘don't care’ and an acceptable lower bound/upper bound or range of values.

As explained above, a responder AP may have its own minimum requirements. When not met by the capabilities in the MAPC Negotiation Request, the responder may reject the request, with one or a list of status codes or a bitmap (e.g., one bit per optional requestable capability as listed above). A sample of one of the status codes may be:
support for one or more MAPC techniques, including Coordinated-Time Division Multiple Access (Co-TDMA), Coordinated Spatial Reuse (Co-SR), Coordinated Restricted Target Wake Time Co-RTWT) and Coordinated Beamforming (Co-BF) are required but not met;
no overlap between the supported MAPC techniques of the first AP and the second AP;
potential for not operating on the same primary channel with operation on different primary channels not supported; and
different vendor/SKU/untrusted code version between the first AP and the second AP; the responder AP may also indicate that certain enabled capabilities are required (i.e., similar to a two-way “Operation element”) that the requester also agrees to.

After a MAPC agreement is setup, the peer AP might not behave as “collegially” as expected. Thus, a one-stage (immediate teardown) or two-stage (notice requiring remediation then, if not remediated, teardown) teardown process may be employed. The two-stage teardown process may include a first stage involving a notice that requires remediation of an issue to avoid imminent termination of the MAPC agreement and a second stage by which, if the issue is not remediated, the MAPC process is terminated. At least one reason is included for each stage of the two-stage teardown process, the at least one reason selected from one or more of:
MAPC agreement no longer needed: e.g., this AP is stopping/changing channel/no more Quality of Service (QoS) traffic, etc.
Policing: Start time protection rule not honored by peer AP/BSS that is to be addressed to avoid a teardown
Policing: Peer AP/BSS does not use requested medium resources that is to be addressed to avoid a teardown
Policing: Peer AP/BSS under-utilizes requested and agreed medium resources that is to be addressed to avoid a teardown
Policing: Peer AP/BSS takes more resources than requested and agreed that it is to be addressed to avoid a teardown
Policing: Peer AP/BSS is triggering NPCA at sender's BSS but ending the TXOP prematurely and thereby gaining a channel access advantage

The two stages may be distinguished via two different frames or the same frame with a field having two different values. The same reason signaling may be used for both types of frames/fields, but their meaning is different/changes according to the frame type/field value (i.e., whether “[to be addressed to avoid a teardown]” applies or not).

To enable AP SKU and SW version based MAPC authorization, each AP SW version may include a challenge/response protocol to be able to demonstrate that it was running the SW version that it asserted that it was running. For instance, each SW version may be delivered (shipped) with a certification with a public/private key pair.

AP-to-AP security/privacy can be added to the exchange when possible (e.g., Pre-Association Security Negotiation (PASN), Simultaneous Authentication of Equals (SAE) etc.) where common credentials are provided using authentication techniques now known or hereinafter developed.

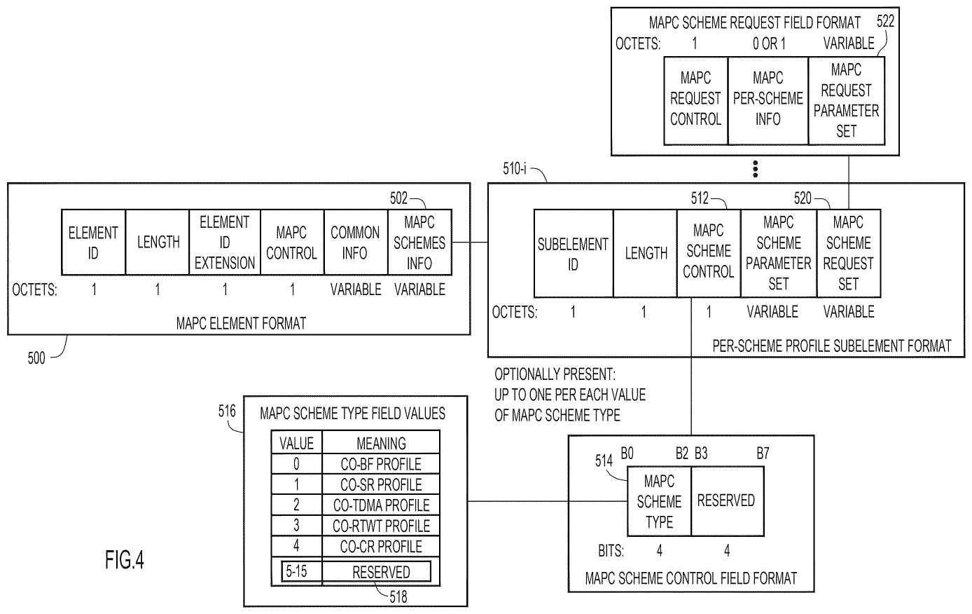

Reference is now made to FIG. 4. FIG. 4 shows an organization of a MAPC element, aspects of which may be enhanced to implement techniques presented herein. A MAPC element 500 includes several fields including a MAPC Schemes Info field 502. The MAPC Schemes Info field 502 contains multiple Per-Scheme Profile subelements 510-i (e.g., one for each MAPC Scheme Type (e.g., Co-BF, Co-SR, Co-TDMA, Co-RTWT, etc.). According to the techniques presented herein, a new Scheme Type (with its own subelement) may be defined. The Per-Scheme Profile subelement 510-i has a MAPC Scheme Control field 512 for scheme identification. A new value is allocated for a MAPC Scheme Type 514 that is part of the MAPC Scheme Control field 512. The MAPC Scheme Type field values 516 include values 5-15 that are Reserved, and one of these values may be used for a new Scheme Type (new type of MAPC agreement), such as Co-TXOP or Co-EDCA, for example, as shown at reference numeral 518.

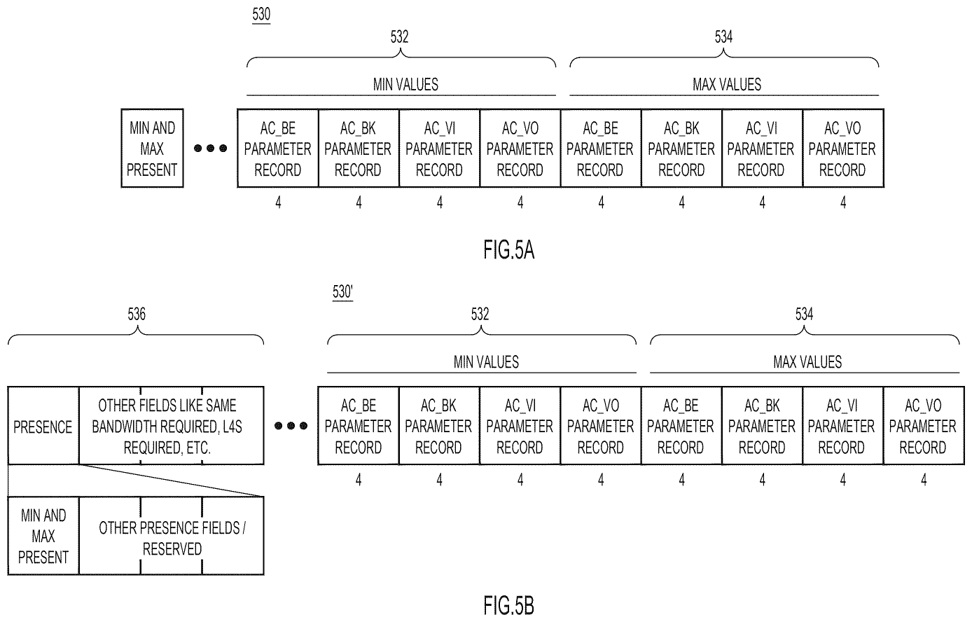

Also, in the Per-Scheme Profile subelement 510-i, there is a MAPC Scheme Request Set field 520 which in turn has a few fields including the MAPC Request Parameter Set field 522. In one embodiment, the MAPC Request Parameter Set field 522 may be used in various ways to denote values for each parameter, as described now in connection with FIGS. 5A and 5B.

FIG. 5A shows, at reference numeral 530, a first mechanism to express the minimum and maximum values of each parameter. There are pre-existing ways to define EDCA values, for example. The first mechanism involves duplicating these ways with a first set of values 532 used for “min” values and a second set of values 534 used for “max” values and thereby define a range (via (4*4+4*4=4*8 octets). Alternatively, for parameters in which min=max, a required value is defined. Still further, if a min value is a “min possible to signal” and a max value is “max possible to signal,” then these values are “don't care” values.

This assumes the min and max present fields are both 1. It is possible that just the min is present or allowed (4*4 and not 4*8 octets). In this case, everything is a range from min on upwards. Conversely, if just the max is present or allowed (4*4 and not 4*8 octets), and then everything is a range from max on downwards. Alternatively, it is established for each parameter whether the signaled value is a min or a max (and these extrema are signaled using a single instance of 4*4 octets).

FIG. 5B shows an arrangement for a second mechanism 530′ that is similar to the first mechanism 530 but allows for more than minimum and maximum (min and max) on EDCA parameters, for example. The second mechanism 530′ includes extra fields 536 for same-BW required, L4S required etc., and the min and max formatting of the first mechanism 530 of FIG. 5A (with variants as described above in conjunction with FIG. 5A).

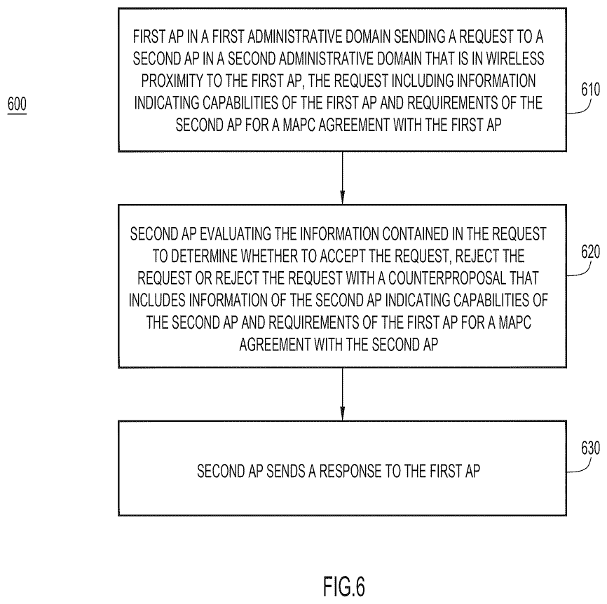

FIG. 6 is a flow chart that depicts, at a high-level, a method 600 for MAPC across administrative domains. The method 600 involves, at step 610, a first AP in a first administrative domain sending a request to a second AP in a second administrative domain that is in wireless proximity to the first AP, the request including information indicating capabilities of the first AP and requirements of the second AP for a MAPC agreement with the first AP. The requirements of the second AP may be defined as a minimum, a maximum or a range of tolerable values for each parameter among a list of one or more parameters. The “range” may be one value only. Moreover, the list includes at least one parameter related to fair channel access and/or channel access enabling better Quality of Service (QoS) or reliability. Fair channel access may involve not overly long TXOP limits for clients (e.g., greater than IEEE 802.11-defined or Wi-Fi Alliance (WFA)-defined defaults), nor very low values of Arbitration Interfame Space Number (AIFSN)/CWmin/CWmax especially for lower priority ACs. This is similar for APs (but potentially higher than limits for clients such as expressed by IEEE 802.11 defaults), i.e., minimum, maximum or range of tolerable parameters. Channel access enabling better QoS/reliability may involve mandatory support for RTWT and/or triggered access, Stream Classification Service with QoS characteristics (SCS(QC)), etc.

At step 620, the method 600 involves the second AP evaluating the information contained in the request to determine whether to accept the request, reject the request or reject the request with a counterproposal that includes information of the second AP indicating capabilities of the second AP and requirements of the first AP for a MAPC agreement with the second AP. The requirements of the first AP are defined as a minimum, maximum or range of tolerable values for each parameter among the list of one or more parameters, and may include at least one parameter related to fair channel access and/or channel access enabling better QoS or reliability, as described above in connection with step 610.

At step 630, based on the evaluating step 620, the second AP sends a response to the first AP.

In method 600, when evaluating at step 620 determines that the requirements of the second AP are not met by the capabilities of the first AP indicated in the request, the response is a rejection of the request and includes a status code for the second AP rejecting the request for the MAPC agreement with the first AP. When evaluating at step 620 determines that the requirements of the second AP are met by the capabilities and requirements of the first AP in the request, the response is an acceptance of the request. Further still, when evaluating at step 620 determines to reject the request with a counterproposal because the capabilities of the first AP are outside the requirements of the second AP, the information of the second AP indicates which capabilities or minimum requirements of the first AP are one of a selection that includes, for each parameter in the list of one or more parameters, two or more of: a required value, a ‘don't care’ and an acceptable lower bound/upper bound or range of values. The required value, “don't care” etc., may apply to each parameter in a list of one or more parameters, and each parameter could have different conditions (e.g., parameter1 has a min condition then parameter2 has a max condition then parameter3 has a range condition). Moreover, the status code may indicate one or more among a plurality of allowed status codes that include one or more of: support for one or more MAPC techniques, including Coordinated-Time Division Multiple Access (Co-TDMA), Coordinated Spatial Reuse (Co-SR), Coordinated Restricted Target Wake Time Co-RTWT) and Coordinated Beamforming (Co-BF) are required but not met; no overlap between the supported MAPC techniques of the first AP and the second AP; potential for operating different primary channels not supported; and different vendor/SKU/untrusted code version between the first AP and the second AP. For example, there may be a definition of just one of these, and signaling only allows one status code to be sent, or there may be a definition of 2, 3 or 4 of these and signaling allows only one status code to be sent, or there may be a definition of 2, 3, or 4 of these and signaling allows multiple status codes to be sent.

The capabilities and minimum requirements included in the request are included in two distinct elements or fields, and each includes one or more of:
Support for one or more MAPC techniques required;
Operation on the same primary channel;
Operation on different primary channels;
Operation on the same NPCA primary channel;
Operation on different NPCA primary channels;
Operation on the same primary channel for two or more links of a multi-link device configured for multi-link operation;
Supports TXOP limits (including proposed minimum/maximum limits);
Supports Low Latency, Low Loss and Scalable (L4S)/Supports cross-coupled L4S;
Supports a protocol to report immediate traffic needs of a Basic Service Set (BSS) in a control frame within a TXOP used for MAPC;
Supports AP2AP triggering (and minimum padding);
Respects start time protection rule (for Co-RTWT);
Supports Co-TDMA within Co-RTWT service periods; and
AP is from the same vendor, SKU and/or is running a trusted/signed version of code.

As explained above, after the MAPC agreement between the first AP and the second AP has been set up, the first AP may teardown the MAPC agreement with the second AP using either a one-stage immediate teardown process or a two-stage teardown process. The two-stage teardown process may include a first stage involving a notice that requires remediation of an issue to avoid imminent termination of the MAPC agreement and a second stage by which, if the issue is not remediated, the MAPC agreement is terminated. At least one reason may be included for each stage of the two-stage teardown process, the at least one reason selected from one or more of:
MAPC agreement no longer needed;
Policing: Start time protection rule not honored by peer AP/Basic Service Set (BSS) that is to be addressed to avoid a teardown;
Policing: Peer AP/BSS does not use requested medium resources that is to be addressed to avoid a teardown;
Policing: Peer AP/BSS under-utilizes requested and agreed medium resources that is to be addressed to avoid a teardown;
Policing: Peer AP/BSS takes more resources than requested and agreed that it is to be addressed to avoid a teardown; and
Policing: Peer AP/BSS is triggering NPCA at other AP's BSS but ending a transmit opportunity (TXOP) prematurely and thereby gaining a channel access advantage.

The first stage and the second stage of the two-stage teardown process may be distinguished via two different frames or a same frame with a field having two different values, and reason code signaling may be used for the two different frames or two different fields that is the same but a meaning of the reason code signaling changes according to the frame type/field value.

The method 600 may further include the first AP or the second AP sending an experience report to a cloud-based resource, the experience report indicating a positive experience or negative experience of the MAPC agreement related operations with each other, where the report is tagged with an indicator of a vendor, model and/or software (SW) version of the first AP and/or the second AP. There may be a first cloud-based resource associated with the first administrative domain that receives experience reports for the first AP and other APs in the first administrative domain, and a second cloud-based resource is associated with the second administrative domain and receives experience reports for the second AP and other APs in the second administrative domain. The first cloud-based resource may analyze experience reports received from the first AP and other APs in the first administrative domain to establish an allow list of sufficiently trustworthy AP models and/or software versions and/or a deny list of insufficiently trustworthy AP models and/or software versions. Similarly, the second cloud-based resource may analyze experience reports received from the second AP and other APs in the second administrative domain to establish an allow list of sufficiently trustworthy AP models and/or software versions and/or a deny list of insufficiently trustworthy AP models and/or software versions. Accordingly, in the method 600, before the first AP sends a request (at step 610) to the second AP, the method may involve the first AP communicating with the first cloud-based resource to determine if the second AP is adequately trustworthy.

As described above, the method 600 may further involve the first AP and/or the second AP initiating a challenge/response protocol with the other AP to permit the first AP or the second AP to demonstrate that it is running a software version that it asserted it was running during MAPC agreement negotiation.

As described above and in further detail below, the capabilities and/or requirements of the first AP and of the second AP that are agreed upon as part of the MAPC agreement include a same or maximum values for one or more transmit opportunity (TXOP) related parameters. The TXOP related parameters may include one or more of:
A TXOP limit for one or more Access Categories (ACs) in use:
a TXOP limit for one or more ACs in a Wireless Multimedia/Enhanced Distributed Channel Access (WMM/EDCA) Parameter Set element advertised to clients of the first AP and/or the second AP;
a TXOP Limit for one or more ACs in a multi-user (MU) EDCA Parameter Set element advertised to clients of the first AP and/or the second AP;
other WMM/EDCA Parameters for one or more ACs including arbitration inter-frame spacing (AIFS) and/or contention window minimum (CWmin) or contention window maximum (CWmax);
TXOP duration Request-to-Send (RTS) threshold sent in a High Efficient (HE) Operation element; and
agreement to not respond to RTS frames whose Duration field exceeds a maximum agreed TXOP Limit.

As will be described in more detail below, as part of the MAPC agreement, the first AP and the second AP may establish multiple sets of coordinated TXOP limits and related parameters, wherein a first set of TXOP limits and related parameters are used when either the first AP or the second AP has urgent/ultra-low latency (LL) traffic sessions active with clients, and a second set of TXOP limits and related parameters are used when either the first AP or the second AP do not have any urgent/ultra LL traffic sessions active with clients.

### TXOP Limits and Related Parameters

According to a further embodiment, techniques are presented herein for two APs to establish Coordinated TXOP Limits. These Coordinated TXOP Limits may be agreed upon by APs that are across administrative domains, as described above in connection with FIG. 1-3, or between APs that are part of the same administrative domain.

The APs may agree on the same or extremum (maximum or minimum as appropriate) values for TXOP-related parameters including one or more of:
a TXOP Limit for one or more Access Categories (ACs) in use by the AP
a TXOP Limit for one or more ACs advertised in a Wireless Multimedia (WMM)/Enhanced Distributed Channel Access (WMM/EDCA) Parameter Set element advertised to clients of the first AP and/or the second AP
a TXOP Limit for one or more ACs in a Multi-User (MU) EDCA Parameter Set element advertised to clients of the first AP and/or the second AP
Other WMM/EDCA Parameters might be negotiated as well for one or more ACs (e.g., Arbitration Inter-frame Spacing (AIFS) and/or Contention Window minimum or maximum (CWmin/CWmax) per AC)
TXOP Duration Request-to-Send (RTS) Threshold sent in the High Efficient (HE) Operation element
Agreement to not respond to RTS frames sent whose Duration field exceeds the maximum agreed TXOP Limit
Priority EDCA (P-EDCA) parameters such as enablement, or CWmin, P-EDCA AIFSN, CW DS, P-EDCA STA Retry Count (PSRC) threshold, P-EDCA QoS STA Retry Count (QSRC) threshold. Prioritized EDCA (P-EDCA) is an enhancement of the EDCA mechanism that reduces the access delay distribution tail for AC_VO (Voice) traffic. The P-EDCA PSRC threshold indicates the maximum number of allowed Distributed System Clear-to-Send (DS-CTS) transmissions. The P-EDA QSRC threshold indicates the value of the QSRC[AC_VO} counter to be allowed to start P-EDCA contention.

These values are used either as a “good until changed/cancelled” arrangement or for use when and while either AP has a session enabled with a client for urgent traffic, especially urgent aperiodic traffic (i.e., an urgent (aperiodic) traffic session).

In one embodiment, the two APs can establish multiple sets of coordinated TXOP limits (and other parameters), where a first set of TXOP limits (and other parameters) are used when either AP has urgent/ultra-low latency (LL) traffic sessions active with clients, and a second set of TXOP limits (and other parameters) are used when APs do not have any urgent/ultra LL traffic sessions active with clients.

In this way, urgent traffic at a client (STA) in the BSS of the first AP or of the second AP should not have to wait too long for TXOPs before the STA can contend (hopefully successfully).

The short TXOP Limit may be used as the main preemption technology as a way to provide preemption at lower latency for a wider range of scenarios.

As part of these techniques, the APs are able to:
Advertise support for this feature
Negotiate these parameters
This advertisement and negotiation might be combined with the mechanisms used for advertising and negotiating other MAPC features, and/or might be subsumed into the advertisement and negotiation of a coordinated preemption feature
Optionally indicate
   the start of any urgent (aperiodic) traffic sessions at the BSS
   the end of all urgent (aperiodic) traffic sessions at the BSS

Advertisement may involve sending a small number (including just one) of high level capability bits related to IEEE 802.11bn and including for instance a MAPC capability field and/or a preemption capability field in a Beacon frame then a request and unicast response frame exchange, where the response includes a (typically non-zero) value in a field where the value indicates capability for a more specific capability such as preemption (including TXOP limits) or TXOP limits (specifically). The request and unicast response frame exchange may be a probe request and probe response or a MAPC Discovery request and Discovery response exchange. The field may be 1 bit (or more). For a 1 bit field, the value might be 1=MAPC TXOP Limit Supported. In a multi-bit field, it is also possible to have tiers of support such as 0=no support, 1=MAPC TXOP Limit Supported, 2=MAPC TXOP Limit and Preemption supported, etc. The field is optionally sent in (fields/subelements/etc.) and ultimately is sent in an element in a frame.

Advertisement may alternatively involve sending the more specific capabilities in fields directly in class 1 management frames such as beacon and probe and MAPC discovery frames. The field for indicating MAPC TXOP Limit Capability may be 1 bit (or more). For a 1 bit field, the value might be 1=MAPC TXOP Limit Supported. In a multi-bit field, it is also possible to have tiers of support such as 0=no support, 1=MAPC TXOP Limit Supported, 2=MAPC TXOP Limit and Preemption supported, etc. The field is optionally sent in (fields/subelements/etc.) and ultimately is sent in an element in a frame.

Negotiation may occur after a secure tunnel is established with a peer AP. The protocol might support negotiation, e.g., between a first AP and a second AP (or, in another embodiment, one or both APs tunnel the information in the frames to the AP's respective wireless LAN controller or central controller which makes the decisions on behalf of the AP), for two or more of the following frame sequences:
Request and response(accept)
request and response(reject)
request and response(counterproposal) then start over
request and response(counterproposal) and response(accept)
request and response(counterproposal) and response(reject)
   where each may use existing (e.g., probe request and probe response) or (possibly protected) frames such as MAPC Negotiation Request and Response frames.

Within the Negotiation Request frame and Negotiation Response, there may be fields including one or more of:
WMM/EDCA Parameters Set element for clients of the first AP or the second AP
a bitmask indicating which fields are required maxima
a bitmask indicating which fields are required minima
a bitmask indicating which fields are required minima and which are required maxima
WMM/EDCA Parameters Set element with a different element identifier for the first AP or the second AP
a field with subfields for:
   a maximum value for a TXOP duration RTS threshold; and
   a bit to indicate if the first AP or the second AP is to not respond to RTS frames sent whose duration field exceeds a maximum agreed TXOP Limit.

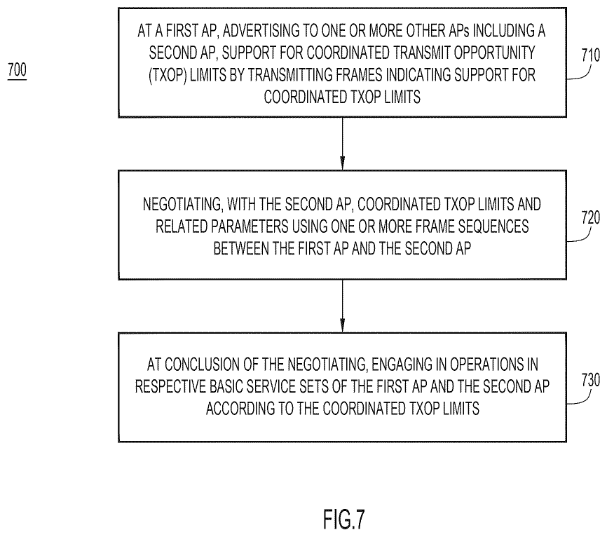

Turning now to FIG. 7, a flow chart is now described that depicts a method 700 according to an example embodiment. The method 700 involves, at step 710, a first access point (AP), advertising to one or more other APs including a second AP, support for coordinated transmit opportunity (TXOP) limits by transmitting frames indicating support for coordinated TXOP limits. At step 720, the method 700 involves negotiating, with the second AP, coordinated TXOP limits and related parameters using one or more frame sequences between the first AP and the second AP. At step 730, the method 700 involves, at conclusion of the negotiating, engaging in operations in respective basic service sets of the first AP and the second AP according to the coordinated TXOP limits.

Step 720 of negotiating may involve the first AP and the second AP negotiating the TXOP related parameters after a secure tunnel is established between the first AP and the second AP, wherein the negotiating includes two or more of the following frame sequences:
request and response(accept);
request and response(reject);
request and response(counterproposal) then start over;
request and response(counterproposal) and response(accept); and
request and response(counterproposal) and response(reject).

In one embodiment, the request and the response are probe request frames and probe response frames, respectively, or are protected frames, including fields comprising one or more of:
Wireless Multimedia/Enhanced Distributed Channel Access (WMM/EDCA) Parameters Set element for clients of the first AP or the second AP;
a bitmask indicating which fields are required maxima;
a bitmask indicating which fields are required minima;
WMM/EDCA Parameters Set element with a different element identifier for the first AP or the second AP;
a field with subfields for:
   a maximum value for a TXOP duration RTS Threshold; and
   a bit to indicate if the first AP or the second AP is to not respond to RTS frames sent whose duration field exceeds a maximum agreed TXOP Limit.

In method 700, the first AP and/or the second AP may advertise support for the TXOP related parameters by transmitting one MAPC capability bit in a Beacon frame followed by a unicast request and response frame exchange, wherein the response includes a value in a field that indicates capability for a more specific capability including preemption (including preemption of TXOP limits) or TXOP limits. Similarly, in method 700, the first AP and/or the second AP may advertise support for the TXOP related parameters by transmitting more specific capabilities in fields directly in class 1 management frames including Beacon frames and other unicast frames.

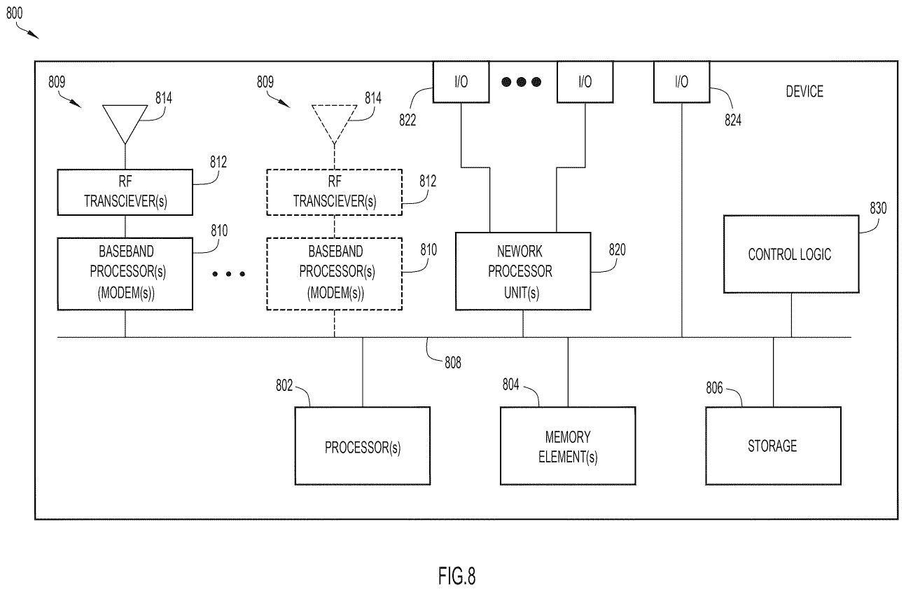

Referring to FIG. 8, FIG. 8 illustrates a hardware block diagram of an apparatus or device 800 that may perform functions associated with operations discussed herein in connection with the techniques described for embodiments herein. Device 800 may be inclusive of any AP device and any client device as discussed for embodiments herein.

In at least one embodiment, the device 800 may be any apparatus that may include one or more processor(s) 802, one or more memory element(s) 804, storage 806, a bus 808, one or more radio modules 809 each consisting of a baseband processor (modem) 810, one or more RF transceivers 812 and an antenna 814 (or group of antennas). The device 800 may further include one or more network processor unit(s) 820 interconnected with one or more network input/output (I/O) interface(s) 822, one or more I/O interface(s) 824, and control logic 830. In various embodiments, instructions associated with logic for device 800 can overlap in any manner and are not limited to the specific allocation of instructions and/or operations described herein.

In at least one embodiment, processor(s) 802 is/are at least one hardware processor configured to execute various tasks, operations and/or functions for device 800 as described herein according to software and/or instructions configured for device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with device 800, and/or logic configured for memory element(s) 804 and/or storage 806. For example, any logic described herein (e.g., control logic 830) can, in various embodiments, be stored for device 800 using any combination of memory element(s) 804 and/or storage 806. Note that in some embodiments, storage 806 can be consolidated with memory element(s) 804 (or vice versa) or can overlap/exist in any other suitable manner.

In at least one embodiment, bus 808 can be configured as an interface that enables one or more elements of device 800 to communicate in order to exchange information and/or data. Bus 808 can be implemented with any architecture designed for passing control, data and/or information between processors, memory elements/storage, peripheral devices, and/or any other hardware and/or software components that may be configured for device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 820 may enable communication between device 800 and other systems, entities, etc., via network I/O interface(s) 822 (wired and/or wireless) to facilitate operations discussed for various embodiments described herein. In various embodiments, network processor unit(s) 820 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between device 800 and other systems, entities, etc. to facilitate operations for various embodiments described herein. In various embodiments, network I/O interface(s) 822 can be configured as one or more Ethernet port(s), Fibre Channel ports, any other I/O port(s), and/or antenna(s)/antenna array(s) now known or hereafter developed. Thus, the network processor unit(s) 820 and/or network I/O interface(s) 822 may include suitable interfaces for receiving, transmitting, and/or otherwise communicating data and/or information (wired and/or wirelessly) in a network environment.

I/O interface(s) 824 allow for input and output of data and/or information with other entities that may be connected to device 800. For example, I/O interface(s) 824 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

The RF transceiver(s) 812 may perform RF transmission and RF reception of wireless signals via antenna(s) 814, and the baseband processor or modem 810 performs baseband modulation and demodulation, etc. associated with such signals to enable wireless communications for device 800.

In various embodiments, control logic 830 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In some aspects, the techniques described herein relate to a method for multi-access point (AP) coordination (MAPC) across administrative domains, including: at a first AP in a first administrative domain sending a request to a second AP in a second administrative domain that is in wireless proximity to the first AP, the request including information indicating capabilities of the first AP and requirements of the second AP for a MAPC agreement with the first AP, wherein the requirements of the second AP are defined as a minimum, a maximum or a range of tolerable values for each parameter among a list of one or more parameters and the list includes at least one parameter related to fair channel access and/or channel access enabling better Quality of Service (QoS) or reliability; and at the second AP: evaluating the information contained in the request to determine whether to accept the request, reject the request or reject the request with a counterproposal that includes information of the second AP indicating capabilities of the second AP and requirements of the first AP for a MAPC agreement with the second AP, wherein the requirements of the first AP are defined as a minimum, maximum or range of tolerable values for each parameter among the list of one or more parameters and include at least one parameter related to fair channel access and/or channel access enabling better QoS or reliability; and sending to the first AP a response based on the evaluating.

In some aspects, the techniques described herein relate to a method, wherein: when evaluating determines that the requirements of the second AP are not met by the capabilities of the first AP indicated in the request, the response is a rejection of the request and includes a status code for the second AP rejecting the request for the MAPC agreement with the first AP; when evaluating determines that the requirements of the second AP are met by the capabilities and requirements of the first AP in the request, the response is an acceptance of the request; and when evaluating determines to reject the request with a counterproposal because the capabilities of the first AP are outside the requirements of the second AP, the information of the second AP indicates which capabilities or minimum requirements of the first AP are one of a selection that includes, for each parameter in the list of one or more parameters, two or more of: a required value, a ‘don't care’ and an acceptable lower bound/upper bound or range of values.

In some aspects, the techniques described herein relate to a method, wherein the status code indicates one or more among a plurality of allowed status codes that include one or more of: support for one or more MAPC techniques, including Coordinated-Time Division Multiple Access (Co-TDMA), Coordinated Spatial Reuse (Co-SR), Coordinated Restricted Target Wake Time Co-RTWT) and Coordinated Beamforming (Co-BF) are required but not met; no overlap between supported MAPC techniques of the first AP and the second AP; potential for operating different primary channels not supported; and different vendor/SKU/untrusted code version between the first AP and the second AP.

In some aspects, the techniques described herein relate to a method, wherein the capabilities and minimum requirements included in the request are included in two distinct elements or fields, and each includes one or more of: Support for one or more MAPC techniques required; Operation on the same primary channel; Operation on different primary channels; Operation on the same NPCA primary channel; Operation on different NPCA primary channels; Operation on the same primary channel for two or more links of a multi-link device configured for multi-link operation; Supports TXOP limits (including proposed minimum/maximum limits); Supports Low Latency, Low Loss and Scalable (L4S)/Supports cross-coupled L4S; Supports a protocol to report immediate traffic needs of a Basic Service Set (BSS) in a control frame within a TXOP used for MAPC; Supports AP2AP triggering (and minimum padding); Respects start time protection rule (for Co-RTWT); Supports Co-TDMA within Co-RTWT service periods; and AP is from the same vendor, SKU and/or is running a trusted/signed version of code.

In some aspects, the techniques described herein relate to a method, wherein after the MAPC agreement between the first AP and the second AP has been set up, the first AP initiating teardown of the MAPC agreement with the second AP using either a one-stage immediate teardown process or a two-stage teardown process.

In some aspects, the techniques described herein relate to a method, wherein the two-stage teardown process includes a first stage involving a notice that requires remediation of an issue to avoid imminent termination of the MAPC agreement and a second stage by which, if the issue is not remediated, the MAPC agreement is terminated.

In some aspects, the techniques described herein relate to a method, wherein at least one reason is included for each stage of the two-stage teardown process, the at least one reason selected from one or more of: MAPC agreement no longer needed; Policing: Start time protection rule not honored by peer AP/Basic Service Set (BSS) that is to be addressed to avoid a teardown; Policing: Peer AP/BSS does not use requested medium resources that is to be addressed to avoid a teardown; Policing: Peer AP/BSS under-utilizes requested and agreed medium resources that is to be addressed to avoid a teardown; Policing: Peer AP/BSS takes more resources than requested and agreed that is to be addressed to avoid a teardown; and Policing: Peer AP/BSS is triggering NPCA at other AP's BSS but ending a transmit opportunity (TXOP) prematurely and thereby gaining a channel access advantage.

In some aspects, the techniques described herein relate to a method, wherein the first stage and the second stage of the two-stage teardown process are distinguished via two different frames or a same frame with a field having two different values, and wherein a reason code signaling is used for the two different frames or two different fields that is the same but a meaning of the reason code signaling changes according to a frame type/field value.

In some aspects, the techniques described herein relate to a method, further including: the first AP or the second AP sending an experience report to a cloud-based resource, the experience report indicating a positive experience or negative experience of MAPC agreement related operations with each other, where the report is tagged with an indicator of a vendor, model and/or software (SW) version of the first AP and/or the second AP.

In some aspects, the techniques described herein relate to a method, wherein a first cloud-based resource is associated with the first administrative domain and receives experience reports for the first AP and other APs in the first administrative domain in connection with MAPC agreement relationships with the second AP and other APs in the second administrative domain, and a second cloud-based resource is associated with the second administrative domain and receives experience reports for the second AP and other APs in the second administrative domain in connection with MAPC agreement relationships with the first AP and other APs in the first administrative domain, the method further including: the first cloud-based resource analyzing experience reports received from the first AP and other APs in the first administrative domain to establish an allow list of sufficiently trustworthy AP models and/or software versions and/or a deny list of insufficiently trustworthy AP models and/or software versions.

In some aspects, the techniques described herein relate to a method, further including, the first AP, before sending a request to the second AP, communicating with the first cloud-based resource to determine if the second AP is adequately trustworthy.

In some aspects, the techniques described herein relate to a method, further including: the first AP and/or the second AP initiating a challenge/response protocol to permit the first AP or the second AP to demonstrate that it is running a software version that it asserted it was running during MAPC agreement negotiation.

In some aspects, the techniques described herein relate to a method, wherein the capabilities and/or requirements of the first AP and of the second AP that are agreed upon as part of the MAPC agreement include a same or maximum values for one or more transmit opportunity (TXOP) related parameters.

In some aspects, the techniques described herein relate to a method, wherein the one or more TXOP related parameters include one or more of: a TXOP limit for one or more Access Categories (ACs) in use: a TXOP limit for one or more ACs in a Wireless Multimedia/Enhanced Distributed Channel Access (WMM/EDCA) Parameter Set element advertised to clients of the first AP and/or the second AP; a TXOP Limit for one or more ACs in a multi-user (MU) EDCA Parameter Set element advertised to clients of the first AP and/or the second AP; other WMM/EDCA Parameters for one or more ACs including arbitration inter-frame spacing (AIFS) and/or contention window minimum (CWmin) or contention window maximum (CWmax); TXOP duration Request-to-Send (RTS) threshold sent in an High Efficient (HE) Operation element; and agreement to not respond to RTS frames whose Duration field exceeds a maximum agreed TXOP Limit.

In some aspects, the techniques described herein relate to a method, wherein as part of the MAPC agreement, the first AP and the second AP establish multiple sets of coordinated TXOP limits and related parameters, wherein a first set of TXOP limits and related parameters are used when either the first AP or the second AP has urgent/ultra-low latency (LL) traffic sessions active with clients, and a second set of TXOP limits and related parameters are used when either the first AP or the second AP do not have any urgent/ultra LL traffic sessions active with clients.

In some aspects, the techniques described herein relate to a method, further including: the first AP and the second AP negotiating the TXOP related parameters after a secure tunnel is established between the first AP and the second AP, wherein negotiating includes two or more of the following frame sequences: request and response(accept); request and response(reject); request and response(counterproposal) then start over; request and response(counterproposal) and response(accept); and request and response(counterproposal) and response(reject).

In some aspects, the techniques described herein relate to a method, wherein the request and the response are probe request frames and probe response frames, respectively, or are protected frames, including fields including one or more of: Wireless Multimedia/Enhanced Distributed Channel Access (WMM/EDCA) Parameters Set element for clients of the first AP or the second AP; a bitmask indicating which fields are required maxima; a bitmask indicating which fields are required minima; WMM/EDCA Parameters Set element with a different element identifier for the first AP or the second AP; and a field with subfields for: a maximum value for a TXOP duration RTS Threshold; and a bit to indicate if the first AP or the second AP is to not respond to RTS frames sent whose duration field exceeds a maximum agreed TXOP Limit.

In some aspects, the techniques described herein relate to a method, further including: the first AP and/or the second AP advertising support for the TXOP related parameters by transmitting one MAPC capability bit in a Beacon frame followed by a unicast request and response frame exchange, wherein the response includes a value in a field that indicates capability for a more specific capability including preemption (including preemption of TXOP limits) or TXOP limits.

In some aspects, the techniques described herein relate to a method, further including: the first AP and/or the second AP advertising support for the TXOP related parameters by transmitting more specific capabilities in fields directly in class 1 management frames including Beacon frames and other unicast frames.

In some aspects, the techniques described herein relate to a system including: a first access point (AP) in a first administrative domain; and a second AP in a second administrative domain that is in wireless proximity to the first AP, wherein the first AP is configured to: send a request to the second AP, the request including information indicating capabilities of the first AP and requirements of the second AP for a MAPC agreement with the first AP, wherein the requirements of the second AP are defined as a minimum, a maximum or a range of tolerable values for each parameter among a list of one or more parameters and the list includes at least one parameter related to fair channel access and/or channel access enabling better Quality of Service (QoS) or reliability; wherein the second AP is configured to: evaluate the information contained in the request to determine whether to accept the request, reject the request or reject the request with a counterproposal that includes information of the second AP indicating capabilities of the second AP and requirements of the first AP for a MAPC agreement with the second AP, wherein the requirements of the first AP are defined as a minimum, maximum or range of tolerable values for each parameter among the list of one or more parameters and include at least one parameter related to fair channel access and/or channel access enabling better QoS or reliability; and send to the first AP a response.

In some aspects, the techniques described herein relate to a system, wherein the second AP evaluates the information contained in the request such that: when determining that the requirements of the second AP are not met by the capabilities of the first AP indicated in the request, the response is a rejection of the request and includes a status code for the second AP rejecting the request for the MAPC agreement with the first AP; when determining that the requirements of the second AP are met by the capabilities and requirements of the first AP in the request, the response is an acceptance of the request; and when determining to reject the request with a counterproposal because the capabilities of the first AP are outside the requirements of the second AP, the information of the second AP indicates which capabilities or minimum requirements of the first AP are one of a selection that includes, for each parameter in the list of one or more parameters, two or more of: a required value, a ‘don't care’ and an acceptable lower bound/upper bound or range of values.

In some aspects, the techniques described herein relate to a system, wherein after the MAPC agreement between the first AP and the second AP has been set up, the first AP initiates teardown of the MAPC agreement with the second AP using either a one-stage immediate teardown process or a two-stage teardown process.

In some aspects, the techniques described herein relate to a system, further including: a first cloud-based resource associated with the first administrative domain that receives experience reports for the first AP and other APs in the first administrative domain in connection with MAPC agreement relationships with the second AP and other APs in the second administrative domain; and a second cloud-based resource associated with the second administrative domain that receives experience reports for the second AP and other APs in the second administrative domain in connection with MAPC agreement relationships with the first AP and other APs in the first administrative domain, wherein the experience reports indicate a positive experience or negative experience of MAPC agreement related operations with each other, where the report is tagged with an indicator of a vendor, model and/or software (SW) version of the first AP and/or the second AP.

In some aspects, the techniques described herein relate to a system, wherein the first cloud-based resource analyzes experience reports received from the first AP and other APs in the first administrative domain to establish an allow list of sufficiently trustworthy AP models and/or software versions and/or a deny list of insufficiently trustworthy AP models and/or software versions, and wherein the first AP, before sending a request to the second AP, communicates with the first cloud-based resource to determine if the second AP is adequately trustworthy.

In some aspects, the techniques described herein relate to a method including: at a first access point (AP), advertising to one or more other APs including a second AP, support for coordinated transmit opportunity (TXOP) limits by transmitting frames indicating support for coordinated TXOP limits; negotiating, with the second AP, coordinated TXOP limits and related parameters using one or more frame sequences between the first AP and the second AP; and at conclusion of the negotiating, engaging in operations in respective basic service sets of the first AP and the second AP according to the coordinated TXOP limits.

In some aspects, the techniques described herein relate to a method, wherein the advertising and the negotiating are performed in combination with advertising and negotiating other multi-access point coordination (MAPC) features between APs in the same administrative domain or in different administrative domains.

In some aspects, the techniques described herein relate to a method, wherein the first AP and the second AP establish multiple sets of coordinated TXOP limits and related parameters, wherein a first set of TXOP limits and related parameters are used when either the first AP or the second AP has urgent/ultra-low latency (LL) traffic sessions active with clients, and a second set of TXOP limits and related parameters are used when either the first AP or the second AP do not have any urgent/ultra LL traffic sessions active with clients.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method for multi-access point (AP) coordination (MAPC) across administrative domains, comprising:
at a first AP in a first administrative domain sending a request to a second AP in a second administrative domain that is in wireless proximity to the first AP, the request including information indicating capabilities of the first AP and requirements of the second AP for a MAPC agreement with the first AP, wherein the requirements of the second AP are defined as a minimum, a maximum or a range of tolerable values for each parameter among a list of one or more parameters and the list includes at least one parameter related to fair channel access or channel access enabling better Quality of Service (QoS) or reliability; and
at the second AP:
evaluating the information contained in the request to determine whether to accept the request, reject the request or reject the request with a counterproposal that includes information of the second AP indicating capabilities of the second AP and requirements of the first AP for a MAPC agreement with the second AP, wherein the requirements of the first AP are defined as a minimum, maximum or range of tolerable values for each parameter among the list of one or more parameters and include at least one parameter related to fair channel access or channel access enabling better QoS or reliability; and
sending to the first AP a response based on the evaluating.

2. The method of claim 1, wherein:
when evaluating determines that the requirements of the second AP are not met by the capabilities of the first AP indicated in the request, the response is a rejection of the request and includes a status code for the second AP rejecting the request for the MAPC agreement with the first AP;
when evaluating determines that the requirements of the second AP are met by the capabilities and requirements of the first AP in the request, the response is an acceptance of the request; and
when evaluating determines to reject the request with a counterproposal because the capabilities of the first AP are outside the requirements of the second AP, the information of the second AP indicates which capabilities or minimum requirements of the first AP are one of a selection that includes, for each parameter in the list of one or more parameters, two or more of: a required value, a ‘don't care’ and an acceptable lower bound/upper bound or range of values.

3. The method of claim 2, wherein the status code indicates one or more among a plurality of allowed status codes that include one or more of:
support for one or more MAPC techniques, including Coordinated-Time Division Multiple Access (Co-TDMA), Coordinated Spatial Reuse (Co-SR), Coordinated Restricted Target Wake Time Co-RTWT) and Coordinated Beamforming (Co-BF) are required but not met;
no overlap between supported MAPC techniques of the first AP and the second AP; and
potential for operating different primary channels not supported.

4. The method of claim 2, wherein the capabilities and minimum requirements included in the request are included in two distinct elements or fields, and each includes one or more of:
support for one or more MAPC techniques required;
operation on a same primary channel;
operation on different primary channels;
operation on a same Non-Primary Channel Access (NPCA) primary channel;
operation on different NPCA primary channels;
operation on the same primary channel for two or more links of a multi-link device configured for multi-link operation;
support for Transmit Opportunity (TXOP) limits (including proposed minimum/maximum limits);
support for Low Latency, Low Loss and Scalable (L4S)/Supports cross-coupled L4S;
support for a protocol to report immediate traffic needs of a Basic Service Set (BSS) in a control frame within a TXOP used for MAPC;
support for AP-to-AP (AP2AP) triggering;
respects start time protection rule for Coordinated Restricted Target Wake Time (Co-RTWT);
support for Coordinated-Time Division Multiple Access (Co-TDMA) within Co-RTWT service periods; and
AP is from a same vendor.

5. The method of claim 1, wherein after the MAPC agreement between the first AP and the second AP has been set up, the first AP initiating teardown of the MAPC agreement with the second AP using either a one-stage immediate teardown process or a two-stage teardown process.

6. The method of claim 5, wherein the two-stage teardown process includes a first stage involving a notice that requires remediation of an issue to avoid imminent termination of the MAPC agreement and a second stage by which, if the issue is not remediated, the MAPC agreement is terminated.

7. The method of claim 6, wherein at least one reason is included for each stage of the two-stage teardown process, the at least one reason selected from one or more of:
MAPC agreement no longer needed;
start time protection rule not honored by peer AP/Basic Service Set (BSS) that is to be addressed to avoid a teardown;
peer AP/BSS does not use requested medium resources that is to be addressed to avoid a teardown;
peer AP/BSS under-utilizes requested and agreed medium resources that is to be addressed to avoid a teardown;
peer AP/BSS takes more resources than requested and agreed that it is to be addressed to avoid a teardown; and
peer AP/BSS is triggering Non-Primary Channel Access (NPCA) at other AP's BSS but ending a transmit opportunity (TXOP) prematurely and thereby gaining a channel access advantage.

8. The method of claim 6, wherein the first stage and the second stage of the two-stage teardown process are distinguished via two different frames or a same frame with a field having two different values, and wherein signaling of a reason code is used for the two different frames or two different fields that is the same and a meaning of the signaling of the reason code changes according to a frame type/field value.

9. The method of claim 1, further comprising:
the first AP or the second AP sending an experience report to a cloud-based resource, the experience report indicating a positive experience or negative experience of MAPC agreement related operations with each other, where the report is tagged with an indicator of a vendor, model or software version of the first AP or of the second AP.

10. The method of claim 9, wherein a first cloud-based resource is associated with the first administrative domain and receives experience reports for the first AP and other APs in the first administrative domain in connection with MAPC agreement relationships with the second AP and other APs in the second administrative domain, and a second cloud-based resource is associated with the second administrative domain and receives experience reports for the second AP and other APs in the second administrative domain in connection with MAPC agreement relationships with the first AP and other APs in the first administrative domain, the method further comprising:
the first cloud-based resource analyzing experience reports received from the first AP and other APs in the first administrative domain to establish an allow list of sufficiently trustworthy AP models or software versions, and a deny list of insufficiently trustworthy AP models or software versions.

11. The method of claim 10, further comprising, the first AP, before sending a request to the second AP, communicating with the first cloud-based resource to determine if the second AP is adequately trustworthy.

12. The method of claim 1, further comprising:
the first AP or the second AP initiating a challenge/response protocol to permit the first AP or the second AP to demonstrate that it is running a software version that it asserted it was running during MAPC agreement negotiation.

13. The method of claim 1, wherein the capabilities or requirements of the first AP and of the second AP that are agreed upon as part of the MAPC agreement include a same or maximum values for one or more transmit opportunity (TXOP) related parameters.

14. The method of claim 13, wherein the one or more TXOP related parameters include one or more of:
a TXOP limit for one or more Access Categories (ACs) in use:
a TXOP limit for one or more ACs in a Wireless Multimedia/Enhanced Distributed Channel Access (WMM/EDCA) Parameter Set element advertised to clients of the first AP or the second AP;
a TXOP Limit for one or more ACs in a multi-user (MU) EDCA Parameter Set element advertised to clients of the first AP or the second AP;
other WMM/EDCA Parameters for one or more ACs including arbitration inter-frame spacing (AIFS) or contention window minimum (CWmin) or contention window maximum (CWmax);
a TXOP duration Request-to-Send (RTS) threshold sent in a High Efficient (HE) Operation element; and
agreement to not respond to RTS frames whose Duration field exceeds a maximum agreed TXOP Limit.

15. The method of claim 13, wherein as part of the MAPC agreement, the first AP and the second AP establish multiple sets of coordinated TXOP limits and related parameters, wherein a first set of TXOP limits and related parameters are used when either the first AP or the second AP has urgent/ultra-low latency (LL) traffic sessions active with clients, and a second set of TXOP limits and related parameters are used when either the first AP or the second AP do not have any urgent/ultra LL traffic sessions active with clients.

16. The method of claim 13, further comprising:
the first AP and the second AP negotiating the TXOP related parameters after a secure tunnel is established between the first AP and the second AP,
wherein negotiating includes two or more of the following frame sequences:
request and response(accept);
request and response(reject);
request and response(counterproposal) then start over;
request and response(counterproposal) and response(accept); and
request and response(counterproposal) and response(reject).

17. The method of claim 16, wherein the request and the response are probe request frames and probe response frames, respectively, or are protected frames, including fields comprising one or more of:
Wireless Multimedia/Enhanced Distributed Channel Access (WMM/EDCA) parameters set element for clients of the first AP or the second AP;
a bitmask indicating which fields are required maxima;
a bitmask indicating which fields are required minima;
WMM/EDCA Parameters Set element with a different element identifier for the first AP or the second AP; and
a field with subfields for:
a maximum value for a TXOP duration RTS Threshold; and
a bit to indicate if the first AP or the second AP is to not respond to Request-to-Send (RTS) frames sent whose duration field exceeds a maximum agreed TXOP Limit.

18. The method of claim 13, further comprising:
the first AP or the second AP advertising support for the TXOP related parameters by transmitting one MAPC capability bit in a Beacon frame followed by a unicast request and response frame exchange, wherein the response includes a value in a field that indicates capability for a more specific capability including preemption (including preemption of TXOP limits) or TXOP limits.

19. The method of claim 13, further comprising:
the first AP or the second AP advertising support for the TXOP related parameters by transmitting more specific capabilities in fields directly in class 1 management frames including Beacon frames and other unicast frames.

20. A system comprising:
a first access point (AP) in a first administrative domain; and
a second AP in a second administrative domain that is in wireless proximity to the first AP,
wherein the first AP is configured to:
send a request to the second AP, the request including information indicating capabilities of the first AP and requirements of the second AP for a MAPC agreement with the first AP, wherein the requirements of the second AP are defined as a minimum, a maximum or a range of tolerable values for each parameter among a list of one or more parameters and the list includes at least one parameter related to fair channel access or channel access enabling better Quality of Service (QoS) or reliability;
wherein the second AP is configured to:
evaluate the information contained in the request to determine whether to accept the request, reject the request or reject the request with a counterproposal that includes information of the second AP indicating capabilities of the second AP and requirements of the first AP for a MAPC agreement with the second AP, wherein the requirements of the first AP are defined as a minimum, maximum or range of tolerable values for each parameter among the list of one or more parameters and include at least one parameter related to fair channel access or channel access enabling better QoS or reliability; and
send to the first AP a response.

21. The system of claim 20, wherein the second AP evaluates the information contained in the request such that:
when determining that the requirements of the second AP are not met by the capabilities of the first AP indicated in the request, the response is a rejection of the request and includes a status code for the second AP rejecting the request for the MAPC agreement with the first AP;
when determining that the requirements of the second AP are met by the capabilities and requirements of the first AP in the request, the response is an acceptance of the request; and
when determining to reject the request with a counterproposal because the capabilities of the first AP are outside the requirements of the second AP, the information of the second AP indicates which capabilities or minimum requirements of the first AP are one of a selection that includes, for each parameter in the list of one or more parameters, two or more of: a required value, a ‘don't care’ and an acceptable lower bound/upper bound or range of values.

22. The system of claim 20, wherein after the MAPC agreement between the first AP and the second AP has been set up, the first AP initiates teardown of the MAPC agreement with the second AP using either a one-stage immediate teardown process or a two-stage teardown process.

23. The system of claim 20, further comprising:
a first cloud-based resource associated with the first administrative domain that receives experience reports for the first AP and other APs in the first administrative domain in connection with MAPC agreement relationships with the second AP and other APs in the second administrative domain; and
a second cloud-based resource associated with the second administrative domain that receives experience reports for the second AP and other APs in the second administrative domain in connection with MAPC agreement relationships with the first AP and other APs in the first administrative domain,
wherein the experience reports indicate a positive experience or negative experience of MAPC agreement related operations with each other, where the report is tagged with an indicator of a vendor, model or software (SW) version of the first AP or of the second AP.

24. The system of claim 23, wherein the first cloud-based resource analyzes experience reports received from the first AP and other APs in the first administrative domain to establish an allow list of sufficiently trustworthy AP models or software versions, and a deny list of insufficiently trustworthy AP models or software versions, and wherein the first AP, before sending a request to the second AP, communicates with the first cloud-based resource to determine if the second AP is adequately trustworthy.

25. A method comprising:
at a first access point (AP), advertising to one or more other APs including a second AP, support for coordinated transmit opportunity (TXOP) limits by transmitting frames indicating support for coordinated TXOP limits;
negotiating, with the second AP, coordinated TXOP limits and related parameters using one or more frame sequences between the first AP and the second AP; and
at conclusion of the negotiating, engaging in operations in respective basic service sets of the first AP and the second AP according to the coordinated TXOP limits.

26. The method of claim 25, wherein the advertising and the negotiating are performed in combination with advertising and negotiating other multi-access point coordination (MAPC) features between APs in a same administrative domain or in different administrative domains.

27. The method of claim 25, wherein the first AP and the second AP establish multiple sets of coordinated TXOP limits and related parameters, wherein a first set of TXOP limits and related parameters are used when either the first AP or the second AP has urgent/ultra-low latency (LL) traffic sessions active with clients, and a second set of TXOP limits and related parameters are used when either the first AP or the second AP do not have any urgent/ultra LL traffic sessions active with clients.
